(19) United States
(12) Patent Application Publication
(10) Pub. No.: US 2014/0034823 A1
(43) Pub. Date: Feb. 6, 2014

(54) NON-RADIOACTIVE TAGGED CEMENT ADDITIVE FOR CEMENT EVALUATION IN A WELL SYSTEM

(71) Applicant: Catherine Hyde-Barber, Richmond, TX (US)

(72) Inventor: Catherine Hyde-Barber, Richmond, TX (US)

(73) Assignee: BP CORPORATION NORTH AMERICA INC., Houston, TX (US)

(21) Appl. No.: 13/943,886

(22) Filed: Jul. 17, 2013

Related U.S. Application Data
(60) Provisional application No. 61/677,610, filed on Jul. 31, 2012.

(51) Int. Cl. C09K 8/42; G01V 5/10

(52) U.S. Cl. CPC C09K 8/42; G01V 5/10; G01V 5/107; G01V 5/101
USPC 250/269.4; 250/269.1; 250/269.6; 106/638

(57) ABSTRACT

An inert (non-radioactive) tagging material can be added to cement in a wellbore. The non-radioactive tagging material can emit radiation at a specific energy level when irradiated with radiation. A logging tool containing a radiation source can be introduced into a wellbore and activated to emit radiation. The logging tool can detect the radiation emitted from the non-radioactive tags within the wellbore. Accordingly, integrity of cement, particularly low density cements that have a density close to that of fluid provided to or contained within a hydrocarbon-bearing formation, can be determined from the detected radiation.

### CROSS-REFERENCE TO RELATED APPLICATIONS

This application claims priority to U.S. Provisional Patent Application Ser. No. 61/677,610 filed on Jul. 31, 2012, the disclosure of which is incorporated by reference herein in its entirety.

### FIELD

The present application is directed to the field of production of hydrocarbons from wellbores.

### BACKGROUND

Evaluation of cement in a wellbore is important to the operation of a hydrocarbon well. In the evaluation of cement it is important to know if the cement is in the right place, the bond is good, that the cement cures correctly, etc. Should cement surrounding a casing be defective and fail to provide isolation of adjacent zones, water or other undesirable fluid can migrate into the hydrocarbon producing zone thus diluting or contaminating the hydrocarbons within the producing zone.

Typically, cement evaluation is performed using acoustic techniques. In this process, transducers, which emit acoustic energy, are arranged on a tool and lowered into a wellbore. Receivers, which record the attenuation of the acoustic waves as they propagate through the wellbore, are arranged above and below the transducers on the tool. By analyzing the propagation velocity and attenuation of the received acoustic waves, the efficacy and integrity of the cement bond can be evaluated. This technique, however, is not able to accurately determine cement integrity when the cement has a density close to the density of other fluids contained within the wellbore, contained in the formation penetrated by the wellbore, or provided to the wellbore during operations. These low density cements are not easily differentiated from the other fluids on ultrasonic or sonic bond logs. Thus, there is a need to improve the techniques used for cement evaluation in hydrocarbon extracting processes.

### SUMMARY

The present disclosure generally relates to techniques for adding an inert (non-radioactive) tagging material (also referred to herein as a “tag”) to cement used in a wellbore. The non-radioactive tagging material can emit radiation at a specific energy level when irradiated with neutrons. A logging tool containing a neutron source can be introduced to into a wellbore and activated to emit neutrons. The logging tool can detect the radiation emitted from the non-radioactive tags within the wellbore. Accordingly, integrity of cement, particularly low density cements that have a density close to that of fluid provided to or contained within a hydrocarbon-bearing formation, can be determined from the detected radiation.

In some implementations, a method of evaluating a bonding material location in a wellbore is disclosed. The method can include inducing a radiation generating source to emit a first type of radiation into the wellbore; detecting a second type of radiation emitted by the bonding material in response to the bonding material interacting with the first type of radiation; and evaluating, by a processor, the second type of radiation to determine a location of the bonding material in the wellbore.

In some embodiments, a system for evaluating a bonding material location in a wellbore is disclosed. The system can include a radiation generating source arranged on a tool and operable to be provided within a wellbore to emit a first type of radiation into the wellbore; a detector arranged on the tool and operable to detect a second type of radiation emitted by the bonding material in response to the bonding material interacting with the first type of radiation; and a processor in communication with computer-readable instructions that when executed cause the processor to evaluate the second type of radiation to determine a location of the bonding material in the wellbore.

In some embodiments, a composition is disclosed that can include a bonding material operable to be positioned and cured around a wellbore; and a non-radioactive tag material operable to interact with a first type of radiation and emit a second type of radiation at a characteristic energy level.

### BRIEF DESCRIPTION OF THE DRAWINGS

Various features of the implementations can be more fully appreciated, as the same become better understood with reference to the following detailed description of the implementations when considered in connection with the accompanying figures, in which:

FIG. 1 shows an example of a wellbore arrangement for a hydrocarbon producing wellbore in accordance with various implementations of the present disclosure;

FIG. 2 shows an example of a process for evaluating a bond between a tubular member and a bonding material in accordance with various implementations of the present disclosure; and

FIG. 3 shows an example of the configuration of a system for evaluating cement according to various implementations of the present disclosure.

### DETAILED DESCRIPTION

Reference will now be made in detail to various implementations of the present disclosure, examples of which are illustrated in the accompanying drawings. Wherever possible, the same reference numbers will be used throughout the drawings to refer to the same or like parts.

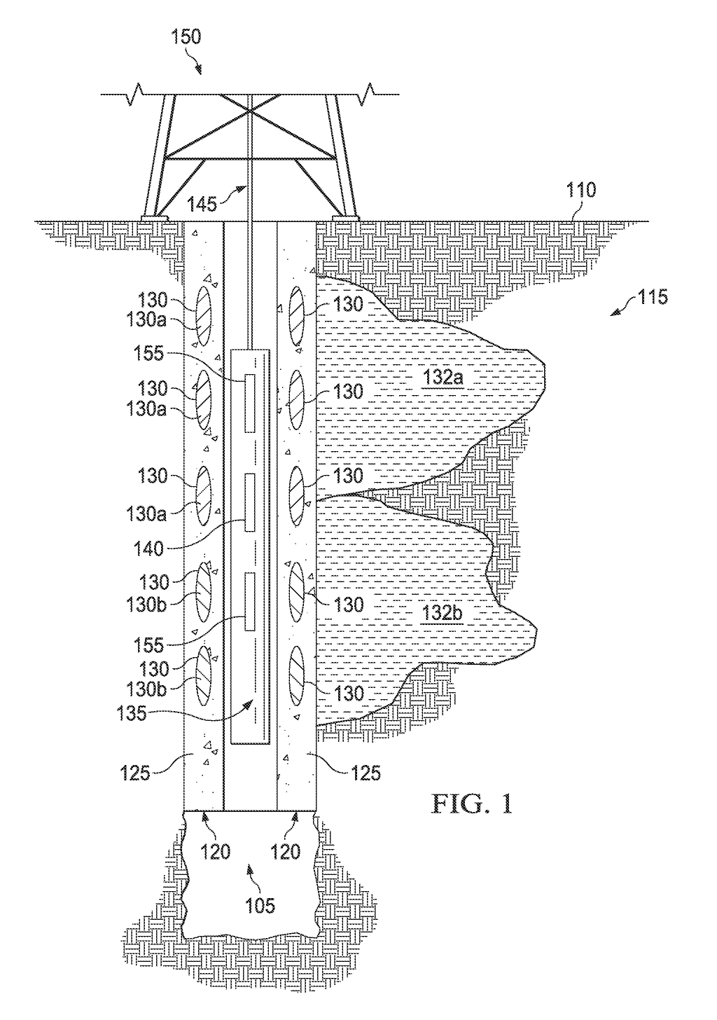

FIG. 1 shows an example of a wellbore arrangement for a hydrocarbon producing well system in accordance with various implementations of the present disclosure. It should be readily apparent to one of ordinary skill in the art that the example of the wellbore arrangement depicted in FIG. 1 represents a generalized schematic illustration and that other components/devices can be added, removed, or modified.

Referring to FIG. 1, a wellbore 105 can be drilled from a surface 110 into a subterranean formation 115 containing hydrocarbons and other materials entrained therein. A casing 120 can be set within the wellbore 105 and can be bonded to the inner surface of the wellbore 105. The casing 120 can be bonded within the wellbore 105 by adding cement 125 within the annulus formed between an outer diameter of the casing 120 and an inner diameter of the wellbore 105. The resulting cement bond not only adheres the casing 120 within the wellbore 105, but can also serve to isolate adjacent zones (132a and 132b) within the formation 115 from one another. Isolation of the adjacent zones 132a and 132b can be useful when one of the zones contains oil or gas and the other zone includes a non-hydrocarbon fluid such as water.

In implementations, the cement 125 can include low density cement, which can have a density close to that of the fluid in the annulus and/or the formation 115. The low density cement can pose an evaluation problem because the acoustic signature between the two materials tends to be very similar. Moreover, in the evaluation of cement, it is important to know if it is in the right place, the bond is good, that the cement cures correctly, etc. Should the cement 125 surrounding the casing 120 be defective and fail to provide isolation of the adjacent zones, water or other undesirable fluid can migrate into the hydrocarbon producing zone thus diluting or contaminating the hydrocarbons within the producing zone.

In implementations, one or more tagging materials 130 can be added to the cement 125 to provide a mechanism from which a cement evaluation and a positive identification of cement versus fluid can be achieved. The tagging materials 130 can be inert and non-radioactive when existing in an environment, but can emit radiation when excited with a specific type of radiation with a specific energy level. For example, the tagging materials 130 can be inert and non-radioactive but, when excited with radiation, can emit radiation.

The tagging material 130 can be any type of material that is responsive to any type of radiation. For example, the radiation used to excite the tagging material 130 can include neutrons, protons, alpha particles, gamma rays, and combinations thereof Likewise, for example, the radiation emitted by the tagging materials 130 can include neutrons, protons, alpha particles, gamma rays, and combinations thereof, depending on the type of the tagging materials 130 and the radiation used to excite the tagging materials 130. In implementations where the exciting radiation includes neutron radiation, the radiation emitted by tagging material can include radiation in the form of gamma rays with a specific energy level.

By way of a non-limiting example, the tagging materials 130 can include a composition of an iron oxide compound. Other suitable compositions may be used so long as they provide the function of facilitating cement evaluation as disclosed herein. The tagging materials 130 can be added directly to cement 125 when the cement is introduced to the wellbore 105. Likewise, the tagging materials 130 can be introduced in the form of ceramic grains that include the tagging materials 130, which can be similar to a proppant used for fracturing.

In implementations, the tagging material 130 can be included in cement anywhere in the wellbore 105 in order to evaluate the cement. Different types of tagging materials 130 can be arranged within the cement 125 to evaluate different zones, such as adjacent zones 132a and 132b. For example, a first tagging material 130a that has a particular detection characteristic, such as emitting a particular radiation or energy level or frequency when excited, can be arranged to be adjacent zone 132a. In this example, a second tagging material 130b having a different detection characteristic can be arranged to be adjacent zone 132b. Different types of the tagging materials 130 can also be used to differentiate different cement jobs in a similar manner.

Although FIG. 1 shows five materials within the annulus, this is merely for illustration purposes only. The size, number, concentration levels, locations of the tagging materials 130 utilized with the cement 125, and detection characteristics of the tagging materials 130 can be chosen to optimize their detection, when excited by a radiation source, within a particular wellbore arrangement as appropriate. Likewise, while the above is described with reference to the wellbore 105 that include the casing 120, the tagging materials 130 can be utilized to evaluate cement in uncased wellbores.

In implementations, to evaluate cement using the tagging materials 130, a downhole tool 135 can be used to provide the tagging materials 130 with radiation and to detect the radiation emitted by the tagging materials 130. The downhole tool 135 can be disposed within the wellbore 105 on a wireline 145 that is connected to a conveyance system 150 via a pulley system or any type of system to lower the downhole tool 135 into the wellbore 105. The downhole tool 135 can include one or more types of tools that can be used to, for example, inspect, measure, and/or detect properties related to, for example, the wellbore 105, the casing 120, the cement 125, and/or the formation 115. In implementations, the downhole tool 135 can include one or more radiation sources 140. The radiation source 140 can be, for example, but not limited to, a neutron source, that is operable to emit radiation, for example, but not limited to, neutrons that can interact with the tagging materials 130. The radiation source 140 can include, for example, a neutron source, such as a minitron or a chemical neutron source. Detectors 155 can be arranged on the downhole tool 135 to receive radiation emitted by the tagging materials 130 due to the interaction with the radiation emitted from the radiation source 140. The detectors 155 can include, for example, but not limited to, a spectral gamma ray detector spaced so that an optimal spectral peak resolution of the tagging materials 130 can be obtained.

By way of example, the downhole tool 135 can be PROPTRAC Logging Tool sold by HEXION of Houston, Tex. Other suitable tools can also be used. In some embodiments, the downhole tool 135 can include multiple radiation sources of the same or different type, one or more detectors of the same or different type. The downhole tool 135 can be lowered into the wellbore using other types of systems such as drill string, etc.

By analyzing the radiation emitted by the tagging materials 130, the cement bond can be evaluated. The gamma ray signature emitted by tagging materials 130 can be detectable through structures, such as, tubing and the casing 120. A cement evaluation log through tubing and the casing 120 can be obtained. By way of a non-limiting example, a composition including a cement material and a non-radioactive tag material is introduced in or around the wellbore at a known location and/or depth. A first position and/or depth in the wellbore 105 can include the composition having the first tagging material 130a and a second position and/or depth in the wellbore 105 can include the composition having the second tagging material 130b. When the tagging materials are excited by radiation from the radiation source 140 within the wellbore 105, the tagging material 130a and 130b can emit radiation at respective characteristic energy levels detected by a one or more of the detectors 155. A region of the cement evaluation log that does not have an expected energy peak where there should be due to the location of the tagging material can indicate that the cement is not properly positioned or that a void exists in the composition that could compromise the wellbore integrity.

Although FIG. 1 shows an example of an arrangement with a single annulus, more than one annulus is possible. In this multiple annuli arrangement, a corresponding cement structure can be arranged for each annulus. In the case of overlapping annuli with cement, different tagging materials 130 can be added to the cement stages to allow the ability to distinguish between the different tagging materials. Moreover, the composition can be used with uncased wells, or in other locations in the wellbore 105. Further, the tagging materials 130 can be added to other materials introduced into the well to evaluate the well.

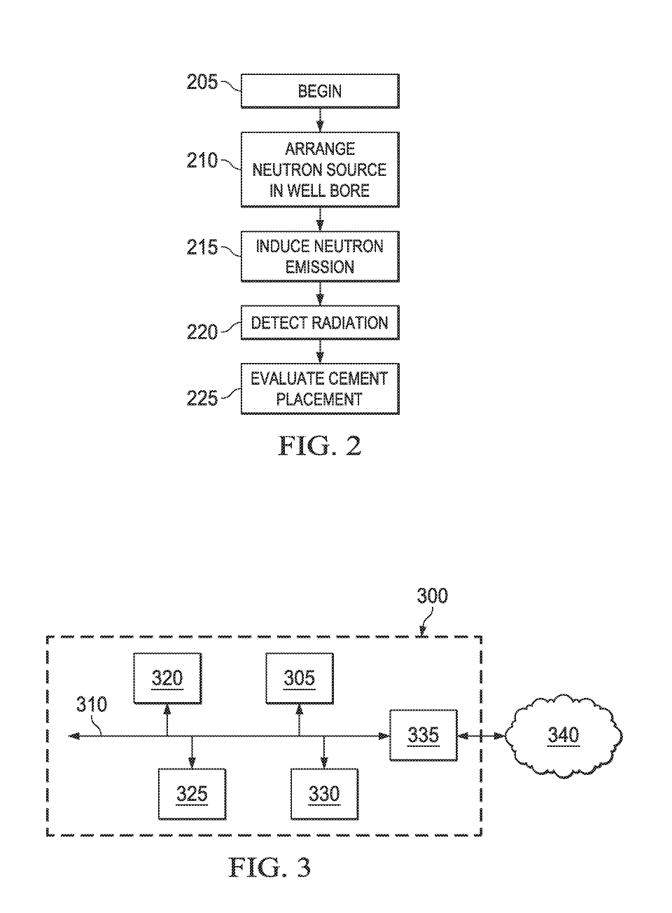

FIG. 2 shows an example of a process for evaluating a bond between a tubular member and a bonding material in accordance with embodiments of the present disclosure. The process can begin at 205. At 210, a radiation generating source, for example, but not limited to a neutron generating source, can be arranged on a tool that is operable to be provided within a wellbore. The tool can include one or more radiation detectors, as discussed above, that are operable to detect or receive radiation emitted from areas of the wellbore.

At 215, the radiation generating source can be induced to emit radiation, for example but not limited to neutrons, into the wellbore to evaluate the bonding material, for example, the cement 125. The tagging materials 130, arranged within the bonding material, can be excited by radiation from a radiation source and can be induced to emit a radiation having a characteristic energy signature that can be analyzed.

At 220, radiation can be detected that is emitted by the tagging materials 130 in the bonding material that is arranged around the wellbore. In implementations, the bonding material can be located in an annulus between a wall of the wellbore and a surface of the tubular member. In implementations, the downhole tool 135 can be raised or lowered to a particular location and/or depth within the wellbore so that the detectors 155 can be properly positioned to detect the emitted radiation.

At 225, a processor can evaluate the cement placement based on the radiation. In embodiments, a log, for example, a cement evaluation log can be used to show amounts of radiation detected with respect to depths within the wellbore 105. If a particular depth within the wellbore does not show an energy peak that was expected based on the location of the tagging material provided to the wellbore, then this could indicate that the cement is not properly positioned or that a void exists in the composition that could compromise the wellbore integrity. For example, the amount of radiation returning to the logging tool can be proportional to the amount of tagged material in place. This technique can be used as an alternate when acquisition of an acoustic log is not possible or difficult to achieve, or as an additional piece of information when questions arise about cement placement.

FIG. 3 shows an example of a configuration of an evaluation system 300 according to implementations of the present disclosure. The evaluation system 300 can be operable to perform the operations described herein to determine integrity of cement in the wellbore 105. Of course, the particular architecture and construction of a computer system useful in connection with this disclosure can vary widely. For example, the evaluation system 300 can be realized by a computer based on a single physical computer, or alternatively by a computer system implemented in a distributed manner over multiple physical computers. The evaluation system 300 can be coupled to the downhole tool 135, the detectors 155, and/or the neutron source 140 in either a wired, for example, by way of a wireline 145 or a wireless manner. In the wireless example, the downhole tool 135 can include a transceiver that is operable to communicate, either directly or over a network, to the evaluation system 300. Accordingly, the architecture illustrated in FIG. 3 is provided merely by way of example.

As shown in FIG. 3, the evaluation system 300 can include a central processing unit 305, coupled to a system bus 310. An input/output interface 320 can also be coupled to the system bus 310, which refers to those interface resources by way of which peripheral functions (e.g., keyboard, mouse, display, etc.) interface with the other constituents of the evaluation system 300. The central processing unit 305 refers to the data processing capability of the evaluation system 300, and as such can be implemented by one or more CPU cores, co-processing circuitry, and the like. The particular construction and capability of the central processing unit 305 can be selected according to the application needs of the evaluation system 300; such needs including, at a minimum, the carrying out of the functions described in this specification, and also including such other functions as may be desired to be executed by a computer system.

In the architecture of the evaluation system 300 according to this example, a data memory 325 and a program memory 330 can be coupled to system bus 310, and can provide memory resources of the desired type useful for their particular functions. The data memory 325 can store input data and the results of processing executed by the central processing unit 305, while the program memory 330 can store the computer instructions to be executed by the central processing unit 305 in carrying out those functions. Likewise, the data memory 325 can store a copy of the computer instructions. Of course, this memory arrangement is only an example, it being understood that the data memory 325 and the program memory 330 can be combined into a single memory resource, or distributed in whole or in part outside of the particular computer system. Typically, the data memory 325 can be realized, at least in part, by high-speed random-access memory in close temporal proximity to central processing unit 305. The program memory 330 can be realized by mass storage or random access memory resources in the conventional manner, or alternatively can be accessible over a network interface 335 (i.e., if the central processing unit 305 is executing a web-based or other remote application) to a network 340.

According to implementations of the disclosure, as mentioned above, the program memory 330 can store computer instructions executable by the central processing unit 305 to carry out the functions described in this specification, by way of which detected radiation is analyzed to determine cement integrity. These computer instructions can be in the form of one or more executable programs, or in the form of source code or higher-level code from which one or more executable programs are derived, assembled, interpreted or compiled. Any one of a number of computer languages or protocols can be used, depending on the manner in which the desired operations are to be carried out. For example, these computer instructions can be written in a conventional high level language, either as a conventional linear computer program or arranged for execution in an object-oriented manner. These instructions can also be embedded within a higher-level application. It is contemplated that those skilled in the art having reference to this description will be readily able to realize, without undue experimentation, this embodiment of the disclosure in a suitable manner for the desired installations. Alternatively, these computer-executable software instructions can, according to embodiments of the disclosure, be resident elsewhere on the network, accessible to the evaluation system 300 via the network interface 335 (for example in the form of a web-based application), or these software instructions can be communicated to the evaluation system 300 by way of encoded information on an electromagnetic carrier signal via some other interface or input/output device.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Certain implementations described above can be performed as a computer applications or programs. The computer program can exist in a variety of forms both active and inactive. For example, the computer program can exist as one or more software programs, software modules, or both that can be comprised of program instructions in source code, object code, executable code or other formats; firmware program(s); or hardware description language (HDL) files. Any of the above can be embodied on a computer readable medium, which include non-transitory computer readable storage devices and media, and signals, in compressed or uncompressed form. Examples of computer readable storage devices and media include conventional computer system RAM (random access memory), ROM (read-only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the present teachings can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the terms “one or more of and “at least one of with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection may be through a direct connection, or through an indirect connection via other devices, components, and connections.

For simplicity and illustrative purposes, the principles of the present teachings are described above by referring mainly to examples of various implementations thereof However, one of ordinary skill in the art would readily recognize that the same principles are equally applicable to, and can be implemented in, many different types of information and systems, and that any such variations do not depart from the true spirit and scope of the present teachings. Moreover, in the preceding detailed description, references are made to the accompanying figures, which illustrate specific examples of various implementations. Electrical, mechanical, logical and structural changes can be made to the examples of the various implementations without departing from the spirit and scope of the present teachings. The preceding detailed description is, therefore, not to be taken in a limiting sense and the scope of the present teachings is defined by the appended claims and their equivalents.

What is claimed is:

1. A method of evaluating a bonding material location in a wellbore, the method comprising:
inducing a radiation generating source to emit a first type of radiation into the wellbore;
detecting a second type of radiation emitted by the bonding material in response to the bonding material interacting with the first type of radiation; and
evaluating, by a processor, the second type of radiation to determine a location of the bonding material in the wellbore.

2. The method according to claim 1, wherein the first type of radiation comprises neutron radiation.

3. The method according to claim 2, wherein the neutron radiation comprises neutrons with energy of about 14.1 MeV.

4. The method according to claim 1, wherein the second type of radiation comprises at least one of neutrons, protons, alpha particles, and gamma rays.

5. The method according to claim 1, wherein the bonding material is arranged in an annulus between a wall of the wellbore and a surface of a tubular member.

6. The method according to claim 1, wherein the bonding material includes a composition including a cement material and a non-radioactive tagging material, wherein the non-radioactive tagging material is operable to interact with the first type of radiation and emit the second type of radiation at a characteristic energy level.

7. The method according to claim 6, wherein the cement material has a density similar to a density of a fluid within the wellbore.

8. The method according to claim 6, wherein the non-radioactive tagging material is inert.

9. The method according to claim 6, wherein the non-radioactive tagging material includes a proppant.

10. A system for evaluating a bonding material location in a wellbore, the system comprising:
a radiation generating source arranged on a tool and operable to be provided within a wellbore to emit a first type of radiation into the wellbore;
a detector arranged on the tool and operable to detect a second type of radiation emitted by the bonding material in response to the bonding material interacting with the first type of radiation; and
a processor in communication with computer-readable instructions that when executed cause the processor to evaluate the second type of radiation to determine a location of the bonding material in the wellbore.

11. The system according to claim 10, wherein the radiation generating source is configured to emit neutron radiation.

12. The system according to claim 11, wherein the neutron radiation comprises neutrons with energy of about 14.1 MeV.

13. The system according to claim 10, wherein the second type of radiation comprises at least one of neutrons, protons, alpha particles, and gamma rays.

14. The system according to claim 10, wherein the bonding material is arranged in an annulus between a wall of the wellbore and a surface of a tubular member.

15. The system according to claim 10, wherein the bonding material includes a composition including a cement material and a non-radioactive tagging material, wherein the non-radioactive tagging material is operable to interact with the first type of radiation and emit the second type of radiation at a characteristic energy level.

16. The system according to claim 15, wherein the cement material has a density similar to a density of a fluid.

17. The system according to claim 15, wherein the non-radioactive tagging material is inert.

18. The system according to claim 15, wherein the non-radioactive tagging material includes a proppant.

19. A composition comprising:
a bonding material operable to be positioned and cured around a wellbore; and
a non-radioactive tagging material co-located with the bonding material and operable to interact with a first type of radiation and emit a second type of radiation at a characteristic energy level.

20. The composition according to claim 19, wherein the bonding material comprises cement.

21. The composition according to claim 19, wherein the non-radioactive tagging material is inert.

22. The composition according to claim 19, wherein the non-radioactive tagging material comprises an iron oxide compound.
